(19) United States
(12) Patent Application Publication
(10) Pub. No.: US 2017/0274724 A1
(43) Pub. Date: Sep. 28, 2017

(54) DAMPING FORCE CONTROL APPARATUS FOR VEHICLE

(71) Applicant: TOYOTA JIDOSHA KABUSHIKI KAISHA, Toyota-shi (JP)

(72) Inventor: Yanqing LIU, Susono-shi (JP)

(73) Assignee: TOYOTA JIDOSHA KABUSHIKI KAISHA, Toyota-shi (JP)

(21) Appl. No.: 15/468,782

(22) Filed: Mar. 24, 2017

(30) Foreign Application Priority Data
Mar. 24, 2016 (JP) 2016-060278

(51) Int. Cl. B60G 17/06; B60G 17/0165; B60G 17/019

(52) U.S. Cl. CPC B60G 17/06; B60G 17/01933; B60G 17/0165

(57) ABSTRACT

The disclosed is a damping force control apparatus for a vehicle which has a control device that stores a reference time that is set to a value within a predetermined range including the resonance period time of the front wheel. When determining that the predetermined vertical displacement portions are present in front of the front wheel on the basis of the detection result of a road surface sensor, the control device sets the damping coefficient of the shock absorber is set to the minimum value by the timing at which the front wheel reaches a predetermined vertical displacement portion, and returns the control of the damping coefficient to the control in accordance with a predetermined control law when a predetermined elapsed time based on the reference time has elapsed from the above timing.

### CROSS-REFERENCE TO RELATED APPLICATION

The disclosure of Japanese Patent Application NO. JP2016-060278 filed on Mar. 24, 2016 is incorporated by reference in its entirety.

### BACKGROUND

1. Technical Field

The present disclosure relates to a damping force control apparatus for a vehicle such as an automobile and the like.

2. Description of the Related Art

In a vehicle such as an automobile, a shock absorber generating a damping force is disposed between a vehicle body (sprung mass) and each wheel (unsprung mass) in order to damp (attenuate) a vibration of the vehicle body when the vehicle is traveling. A damping force generating valve is built in the shock absorber. The damping force generating valve generates a damping force which is equal to a product of a relative vertical speed between the vehicle body and the wheel and a damping coefficient variably set by the damping force generating valve.

The higher the damping force is, the higher an effect of damping the vibration of the vehicle body is. However, an impact which the wheel receives from the road surface is easily transmitted to the vehicle body, and thereby a ride quality of the vehicle is deteriorated. On the contrary, although the ride quality of the vehicle can be improved as the damping force is lower, the vibration of the vehicle body cannot be effectively attenuated, and a driving stability of the vehicle is decreased. Therefore, a damping force variable type shock absorber, which can change the damping force by changing the damping coefficient set by the damping force generating valve, is adopted in some types of vehicles, and a damping force control, which changes the damping coefficient depending on the running state of the vehicle, is carried out.

For example, Japanese Patent Application Laid-open Publication No. 2010-235019 discloses a damping force control apparatus which is used in a vehicle having a damping force variable type shock absorber. The control apparatus sets the damping coefficient to a low damping coefficient (soft) in a normal state, and switches the damping coefficient to a high damping coefficient (hard) after the associated wheel gets over a protrusion of the road surface.

### SUMMARY

In the damping force control apparatus described in the above-mentioned Japanese Patent Application Laid-open Publication, when the vertical relative speed between a vehicle body and a wheel is turned over in stroke from the first extension speed stroke to a compression speed stroke while the wheel gets over a protrusion, the damping coefficient is switched from a low damping coefficient to a high damping coefficient. According to this damping force control apparatus, the ride quality of the vehicle can be improved in a situation where the wheel gets over another protrusion before the vertical relative speed is turned over in stroke, as compared with the case where the damping coefficient is switched to a high damping coefficient during the first compression speed stroke or the first extension speed stroke.

However, a waveform of the vertical relative speed between the vehicle body and the wheel when the wheel gets over a protrusion is not necessarily a waveform in which the strokes of the compression speed and the extension speed simply repeat. Therefore, the damping force control apparatus described in the above-mentioned Japanese Patent Application Laid-open Publication cannot effectively damp the vibration of the vehicle body effectively while effectively reducing an impact applied to the vehicle body when the wheel gets over a protrusion.

The inventor of the present application intensively studied about the control of a damping coefficient for effectively achieving reduction of an impact transmitted to the vehicle body from a front wheel and damping of the vehicle body vibration when the front wheel gets over a predetermined vertical displacement portion such as a protrusion and a step (level difference) which apply an upward excitation force to the front wheel. As a result, it has been found that if the damping coefficient is set to the minimum damping coefficient until a predetermined elapsed time set based on the resonance period of the front wheel elapses from the time when the front wheel reaches a predetermined vertical displacement portion, both reduction of the impact applied to the vehicle body from the wheel and damping of the vibration of the vehicle body can effectively be achieved without detecting the vibration of the vehicle body or the like.

A primary object of exemplary aspects of the present disclosure is to effectively reduce an impact applied to a vehicle body and to effectively damp a vibration of the vehicle body without detecting a vehicle body vibration state such as a relative speed between the vehicle body and the wheel when a front wheel passes through a predetermined vertical displacement portion.

According to one embodiment of the present disclosure, there is provided a damping force control apparatus for a vehicle configured to control a damping force variable type shock absorber which is disposed between each of front wheels and a vehicle body and is configured to vary a damping coefficient to a plurality of values, comprising: a road surface sensor configured to detect a vertical displacement of a road surface at a position which is spaced forward from the front wheel by a predetermined distance; a vehicle speed sensor configured to detect a vehicle speed; and a control unit configured to control the damping coefficient of each shock absorber in accordance with a predetermined control law.

The control unit is configured to store a reference time preset to a value within a predetermined range including a time period of a resonance period of the front wheels when the damping coefficient of the shock absorber is the minimum value among the plurality of values.

The control means is configured: when determining that there is a predetermined vertical displacement portion giving an upward excitation force to the front wheel in front of the front wheel based on a vertical displacement of the road surface detected by the road surface sensor, to estimate a timing when the front wheel reaches a predetermined vertical displacement portion based on the vehicle speed detected by the vehicle speed sensor and the predetermined distance; to set the damping coefficient to the minimum value without following the predetermined control law by the timing is reached; to set a predetermined elapsed time from the timing during which the damping coefficient is maintained at the minimum value based on the reference time; and to return control of the damping coefficient to the control in accordance with the predetermined control law when the predetermined elapsed time has elapsed from the timing.

According to the above configuration, it is possible to set the damping coefficient to the minimum value earlier than the timing at which the front wheel reaches a predetermined vertical displacement portion, to maintain the damping coefficient at the minimum value from the above timing just before the lapse of the predetermined elapsed time which is set based on the reference time, and to reduce an excitation force from the front wheel to the vehicle body. Thus, an impact transmitted from the front wheel to the vehicle body and a vibration of the vehicle body caused by the impact can be effectively reduced when the front wheel passes through a predetermined vertical displacement portion, as compared with the case where, for example, the damping coefficient is set to the minimum value after the front wheel reaches a predetermined vertical displacement portion and the resultant vibration of the vehicle body is detected. It will be described in detail later referring to FIGS. 8 and 9, etc. that the above effect can be obtained by maintaining the damping coefficient at the minimum value until just before the predetermined elapsed time, which is set based on the reference time, lapses from the above timing.

In addition, the control of the damping coefficient is returned to the control in accordance with the predetermined control law when the predetermined elapsed time has lapsed, so that the vibration of the vehicle body can be attenuated using a desired damping coefficient set in accordance with the predetermined control law after the lapse of the predetermined elapsed time. Thus, the vibration of the vehicle body can effectively attenuated as compared with the case where, for example, the damping coefficient is maintained at the minimum value even after the predetermined elapsed time has lapsed.

According to the above configuration, a vibration state of the vehicle body, such as a relative speed between the vehicle body and the wheel, is not detected, and, accordingly, the damping coefficient is not controlled based on a detected result. Thus, the damping coefficient can be set to the minimum value during a required period of time without detecting the vibration state of the vehicle body, which enables to effectively reduce both the impact transmitted from the front wheel to the vehicle body and the vibration of the vehicle body caused by the impact.

In addition, according to the above configuration, the damping force control apparatus controls the damping force variable type shock absorber which can vary a damping coefficient to a plurality of values. Thus, the damping force control apparatus according to the present disclosure can be applied to a vehicle in which the damping coefficient is switched in a multi-step manner or in a continuous manner in accordance with the running condition of the vehicle, and the damping coefficient is controlled to the plurality of values in accordance with the predetermined control law such as the Skyhook theory, the H∞ control theory, or the like in a normal state.

In one aspect of the present disclosure, the control unit is configured: to estimate a time required for the front wheel to pass through the predetermined vertical displacement portion based on the vehicle speed detected by the vehicle speed sensor and a magnitude of the predetermined vertical displacement portion measured in a direction of movement of the front wheel, and to determine that the predetermined vertical displacement portion is an upward step when the estimated time is greater than a quarter of the time period of the resonance period of the vehicle body in the case where the damping coefficient of the shock absorber is the minimum value; to determine that the predetermined vertical displacement portion is a protrusion when the estimated time is not greater than a quarter of the time period of the resonance period of the vehicle body; and to set the predetermined elapsed time in accordance with the result of the determination.

As will be described in detail later, a time required for the front wheel to pass through the predetermined vertical displacement portion can be estimated based on the vehicle speed detected by the vehicle speed sensor and a magnitude of the predetermined vertical displacement portion measured in a direction of movement of the front wheel. When the estimated time is greater than a quarter of the time period of the resonance period of the vehicle body in the situation where the damping coefficient of the shock absorber is the minimum value, the predetermined vertical displacement portion may be determined to be an upward step. On the contrary, the predetermined vertical displacement portion may be determined to be a protrusion when the estimated time is not greater than a quarter of the time period of the resonance period of the vehicle body in the situation where the damping coefficient of the shock absorber is the minimum value.

According to the above aspect, it is possible to determine whether the predetermined vertical displacement portion is a step or a protrusion, and to set a predetermined elapsed time to a suitable value depending on whether the predetermined vertical displacement portion is a step or a protrusion. Therefore, even when the predetermined vertical displacement portion is either a step or a protrusion, it is possible to return the control of the damping coefficient to the control in accordance with the predetermined control law at a time suitable for each of the step and the protrusion.

In another aspect of the present disclosure, the control unit is configured to set the predetermined elapsed time to the reference time when determining that the predetermined vertical displacement portion is an upward step.

According to the above aspect, when it is determined that the predetermined vertical displacement portion is an upward step, the predetermined elapsed time is set to the reference time. Therefore, as will be described later in detail, the control of the damping coefficient can be returned to the control in accordance with the predetermined control law at the time suitable for the case where the predetermined vertical displacement portion is an upward step.

Furthermore, in another aspect of the present disclosure, the control unit is configured to estimate a time period from the timing until a time point when the front wheel has gotten over the protrusion based on the vehicle speed detected by the vehicle speed sensor and a magnitude of the predetermined vertical displacement portion measured in a direction of movement of the front wheel, and to set the predetermined elapsed time to a sum of the estimated time period and the reference time when determining that the predetermined vertical displacement portion is a protrusion.

According to the above aspect, when it is determined that the predetermined vertical displacement portion is a protrusion, the predetermined elapsed time is set to a sum of the time period from the timing until a time point when the front wheel has gotten over the protrusion and the reference time. Thus, as described in detail later, the control of the damping coefficient can be returned to the control in accordance with the predetermined control law at a time suitable for the case where the predetermined vertical displacement portion is a protrusion.

Furthermore, in another aspect of the present disclosure, the reference time is not less than 0.70 times the time period of the resonance period of the front wheel and is not more than 1.18 times the time period of the resonance period of the front wheel.

According to the above aspect, the reference time is not less than 0.70 times the time period of the resonance period of the front wheel and is not more than 1.18 times the time period of the resonance period of the front wheel. Thus, as will be described later in detail, an impact transmitted from the front wheel to the vehicle body and the vibration of the vehicle body caused by the impact can be effectively reduced, as compared with the case where the reference time is less than 0.70 times the time period of the resonance period of the front wheel and the case where the reference time is larger than 1.18 times the time period of the resonance period.

Other objects, other features, and accompanying advantages of the present disclosure are easily understood from the description of embodiments of the present disclosure to be given referring to the following drawings.

### BRIEF DESCRIPTION OF THE DRAWINGS

FIG. 1 is a side view of a vehicle which shows a schema of a damping force control apparatus for a vehicle according to an embodiment of the present disclosure.

FIG. 2 is a plan view showing the vehicle shown in FIG. 1.

FIGS. 3A, 3B, 3C and 3D are explanatory diagrams showing a situation in which a front wheel gets over and passes through a protrusion with a damping coefficient of a shock absorber maintained at a constant value for a single-wheel model of the front wheel.

FIG. 4 are graphs showing an example of changes of an input from road surface, vertical displacements of the front wheel (unsprung mass), the vehicle body (sprung mass) and a suspension, a vertical speed, and a vertical acceleration for a state where the front wheel gets over and passes through a protrusion as shown in FIGS. 3A, 3B, 3C and 3D with the damping coefficient C set to the minimum value C0.

FIG. 5 is a flow chart showing a damping force control routine of the shock absorber of the front wheel according to the embodiment.

FIG. 6 is an explanatory view showing a situation in which the front wheel starts to run over the protrusion.

FIG. 7 is an explanatory view showing a situation in which the front wheel has completed getting over the protrusion.

FIGS. 8A, 8B and 8C are graphs showing an example of changes of an input from the road surface, a vertical displacement of the vehicle body, a vertical speed, a vertical acceleration, and the damping coefficient when the front wheel gets over and passes through a step.

FIG. 9 is a graph showing a relationship between the peak value zbp of the vertical displacement of the vehicle body and the peak value zbddp of the vertical acceleration of the vehicle body for various elapsed time Tc when the front wheel gets over and passes through a step.

FIG. 10 are graphs showing an example of changes of an input from the road surface, vertical displacements of the front wheel, vehicle body, and the suspension, an vertical speed, an vertical acceleration, and the damping coefficient when the front wheel gets over a step.

FIG. 11 are graphs showing an example of changes of an input from the road surface, vertical displacements of the front wheel, the vehicle body and the suspension, a vertical speed, a vertical acceleration, and the damping coefficient when the front wheel gets over and passes through a protrusion.

### DETAILED DESCRIPTION

A detailed description is now given of an embodiment of the present disclosure referring to the drawings.

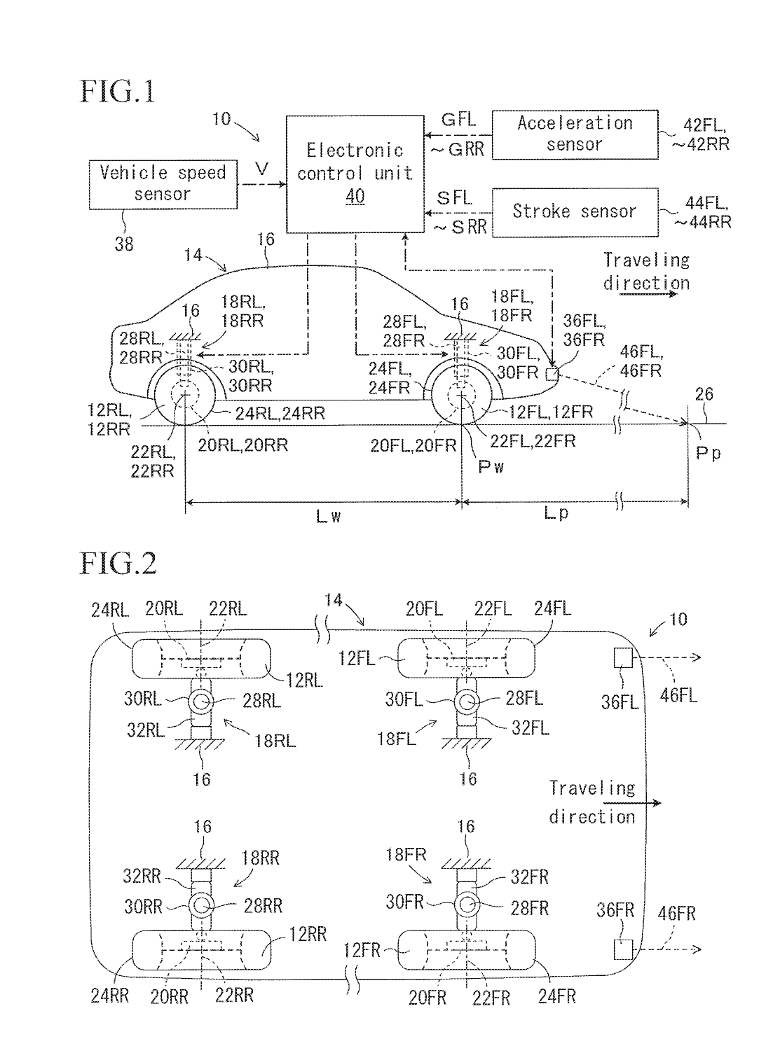

In FIGS. 1 and 2, the damping force control apparatus for vehicle according to the embodiment of the present disclosure is generally indicated by reference numeral 10. The damping force control apparatus 10 is applied to a vehicle 14 including left and right front wheels 12FL and 12FR which are steered wheels, and left and right rear wheels 12RL and 12RR which are non-steerable wheels. The vehicle 14 is provided with front wheel suspensions 18FL and 18FR suspending the front wheels 12FL and 12FR from the vehicle body 16, respectively and rear wheel suspensions 18RL and 18RR suspending the rear wheels 12RL and 12RR from the vehicle body 16, respectively.

The front wheels 12FL and 12FR are supported by corresponding wheel supporting members 20FL and 20FR, respectively, so that the front wheels can rotate about respective rotation axes 22FL and 22FR and have respective tires 24FL and 24FR that are in contact with a road surface 26. Similarly, the rear wheels 12RL and 12RR are supported by corresponding wheel supporting members 20RL and 20RR, respectively, so that the rear wheels can rotate about respective rotation axes 22RL and 22RR and have respective tires 24RL and 24RR that are in contact with the road surface 26.

The front wheel suspensions 18FL and 18FR include damping force variable type shock absorbers 28FL and 28FR, respectively, and suspension springs 30FL and 30FR, respectively. Similarly, the rear wheel suspensions 18RL and 18RR include damping force variable type shock absorbers 28RL and 28RR, respectively, and suspension springs 30RL and 30RR, respectively. Although not shown in detail in the figures, each of the shock absorbers 28FL through 28RR is provided with a damping force generating valve for changing a damping force by changing a damping coefficient C and an actuator for changing the damping coefficient C by driving the damping force generating valve. The actuators are controlled by an electronic control unit 40 which will be described later.

Each of the shock absorbers 28FL through 28RR can change its damping coefficient C in a multi-stage manner from the minimum value C0 which is the minimum damping coefficient, to the maximum value Cn (n is a positive constant integer). The damping coefficient C is controlled to be a value within the range between C0+x and Cn (x is a positive constant integer) in accordance with a predetermined control law during normal running when the wheels 12FL through 12RR run on a road surface which has no upward step (hereinafter simply referred to as “step”) and no protrusion. On the other hand, as will be described in detail later, when the front wheel 12FL or 12FR passes through a step or a protrusion, the damping coefficient of the associated shock absorber 28FL or 28FR is controlled to be the minimum value C0 for a predetermined elapsed time Tc without following the predetermined control law. Notably, the shock absorbers 28FL through 28RR may be configured to be able to change the damping coefficient C continuously.

The shock absorbers 28FL and 28FR are respectively connected to the vehicle body 16 at the upper end thereof, and are connected to the associated wheel supporting members 20FL and 20FR at the lower end thereof. The suspension springs 30FL and 30FR are elastically mounted between the vehicle body 16 and suspension arms 32FL and 32FR or between the vehicle body 16 and the shock absorbers 28FL and 28FR, respectively. The front wheel suspensions 18FL and 18FR allow the associated front wheels 12FL and 12FR to be displaced in the vertical direction with respect to the vehicle body 16. Although each of the suspension arms 32FL and 32FR is shown as one arm in FIG. 2, a plurality of arms may be provided for each of the suspension arms 32FL and 32FR.

Similarly, the shock absorbers 28RL and 28RR are respectively connected to the vehicle body 16 at the upper end thereof, and are connected to the associated wheel supporting members 20RL and 20RR at the lower end thereof. The suspension springs 30RL and 30RR are elastically mounted between the vehicle body 16 and the suspension arms 32RL and 32RR or between the vehicle body 16 and the shock absorbers 28RL and 28RR, respectively. The rear wheel suspensions 18RL and 18RR allow the associated rear wheels 12RL and 12RR to be displaced in the vertical direction with respect to the vehicle body 16. Although each of the suspension arms 32RL and 32RR is shown as one arm in FIG. 2, a plurality of arms may be provided for each of the suspension arms 32RL and 32RR.

The suspensions 18RL through 18RR may be suspensions of any type as long as f the associated wheels 12FL through 12RR are allowed to be displaced in the vertical direction with respect to the vehicle body 16. The suspensions 18RL through 18RR are preferable to be any one of suspensions of independent suspension type such as, for example, a McPherson strut type, a double wishbone type, a multi-link type, and a swing arm type. Further, the suspension springs 30FL through 30RR may be any type of spring such as compression coil springs and air springs.

The damping force control apparatus 10 is provided with road surface sensors 36FL and 36FR, a vehicle speed sensor 38, and an electronic control unit 40. The vehicle speed sensor 38 detects a vehicle speed V. The electronic control unit 40 controls damping forces of the shock absorbers 28FL through 28RR by controlling the damping coefficients C of the shock absorbers. The road surface sensors 36FL and 36FR functions as detecting devices to detect the heights of the road surface 26 at positions in front of the left and right front wheels 12FL and 12FR, respectively. Signals indicating the heights of the road surface 26 which are detected by the road surface sensors 36FL and 36FR, and a signal indicating the vehicle speed V are input to the electronic control unit 40. Signals indicating vertical accelerations GFL through GRR of the vehicle body 16 (the sprung mass) at positions which correspond to the wheels 12FL through 12RR respectively, are also input to the electronic control unit 40 from acceleration sensors 42FL through 42RR, respectively. Furthermore, signals indicating vertical strokes SFL through SRR of the suspensions 18RL through 18RR are also input to the electronic control unit 40 from the stroke sensors 44FL through 44RR, respectively.

Although not shown in detail in FIG. 1, the electronic control unit 40 includes a microcomputer and a driving circuit. The microcomputer has a general configuration including a CPU, a ROM, a RAM and I/O port devices connected to each other by a bidirectional common bus. A control program for controlling the damping forces of the shock absorbers 28FL through 28RR by controlling their damping coefficients C is stored in the ROM. The damping coefficients C are controlled by the CPU in accordance with the control program.

The road surface sensors 36FL and 36FR are provided on the front end of the vehicle body 16, and are positioned in front of the front wheels 12FL and 12FR, respectively. The road surface sensors 36FL and 36FR irradiate laser beams 46FL 46FR to the road surface 26 in front of the front wheels 12FL and 12FR, and detect the heights of the road surface 26 (the height with respect to the straight line connecting the grounding points of the front and rear wheels) by detecting reflected light from the road surface 26. The laser beam is irradiated so that irradiation point is reciprocally moved in the lateral direction while reciprocally moved in the vertical direction. If necessary, see, for example, International Publication WO 2012/32655 for the operation of the road surface sensor and the detection of the height of the road surface, and the like.

As shown in FIG. 1, the irradiation point of the laser beam 46 against the road surface 26 when the amount of reciprocally moving the irradiation point in the vertical direction and the lateral direction is 0, is defined as the detected point Pp of the road surface sensors 36. The distance in the vehicle longitudinal direction between the grounding points Pw of the front wheels 12FL and 12FR and the detected point Pp is defined as the foresight distance Lp. The foresight distance Lp is preferably greater than the wheelbase Lw of the vehicle 14.

It is to be noted that the road surface sensors 36FL and 36FR may be sensors other than the laser beam type sensors as long as they can detect the height of the road surface in front of the vehicle ahead of the front wheels 12FL and 12FR by a predetermined distance. For example, each of the road surface sensors 36FL and 36FR may be a stereo camera, a monocular camera, or a combination of a laser light type sensor and a stereo camera or a monocular camera. In FIGS. 1 and 2, the road surface sensors 36FL and 36FR are installed on a front bumper of the vehicle 14. However, they may be installed at any position on the vehicle, for example the upper edge portion of the inner surface of the windshield, so that they can detect the height of the road surface at positions in front of the front wheels. In addition, the heights of the road surface may be detected by one road surface sensor which is used in place of the left and right road surface sensors 36FL and 36FR.

In the following description, when the left and right front wheels 12FL and 12FR and members provided corresponding to these front wheels are collectively referred to, reference numerals with symbol F signifying the front wheels will be used. Namely, the symbols FL and FR are collectively referred to as the symbol F, and, for example, the term “front wheels 12F” is used as a term indicating the front wheels 12FL and 12FR, and the term “front wheel 12F” is used as a term indicating the front wheel 12FL or 12FR. In similar, the symbols RL and RR are collectively referred to as the symbol R.

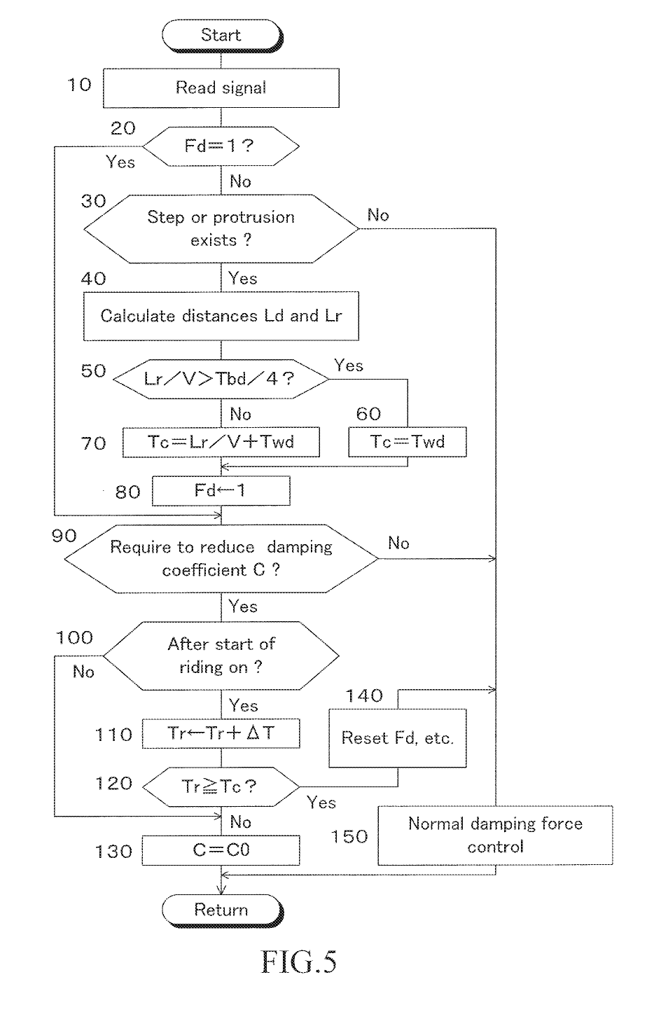

In the embodiment, the electronic control unit 40 controls the damping force of the shock absorbers 28F in accordance with the flow chart shown in FIG. 5. The electronic control unit 40 determines whether or not there is a step or protrusion, which is a predetermined vertical displacement portion giving an upward excitation force to the front wheel 12F, on the basis of the height of the road surface 26 detected by the road surface sensor 36F. When it is determined that the predetermined vertical displacement portion exists, the electronic control unit 40 reduces the damping coefficient C of the shock absorber 28F to the minimum value C0 from the time when the front wheel 12F reaches the predetermined vertical displacement portion over a predetermined elapsed time Tc.

In contrast, when it is not determined that the predetermined vertical displacement portion exists, the electronic control unit 40 performs a normal damping force control on the shock absorber 28F. It should be noted that the normal damping force control may be any damping force control that controls the damping coefficient C of the shock absorber 28F in accordance with a predetermined control law such as Skyhook theory, H∞ control theory, or the like.

The above-mentioned predetermined elapsed time Tc is a time required to effectively reduce the vibration of the vehicle body 16 as the sprung mass when the front wheel 12F passes through the predetermined vertical displacement portion. The elapsed time Tc is set based on the reference time Twd, which is set in advance based on one cycle of the vertical vibration of the front wheel 12F generated when the front wheel 12F passes through the predetermined vertical displacement portion of the road surface. The above predetermined elapsed time Tc differs depending on whether the predetermined vertical displacement portion is a step or a protrusion. When the predetermined vertical displacement portion is a step, the predetermined elapsed time Tc is set to the reference time Twd. In contrast, when the predetermined vertical displacement portion is a protrusion, the elapsed time Tc is set to Lr/V+Twd which is the sum of Lr/V and the reference time Twd. Lr/V is a time estimated to be necessary for the front wheel 12F to pass through a protrusion. It is to be noted that, as will be described later with reference to FIG. 7, Lr is a distance that the front wheel 12F has to move in the traveling direction of the vehicle from when the front wheel 12F starts getting on a protrusion until the front wheel 12F has gotten over the protrusion.

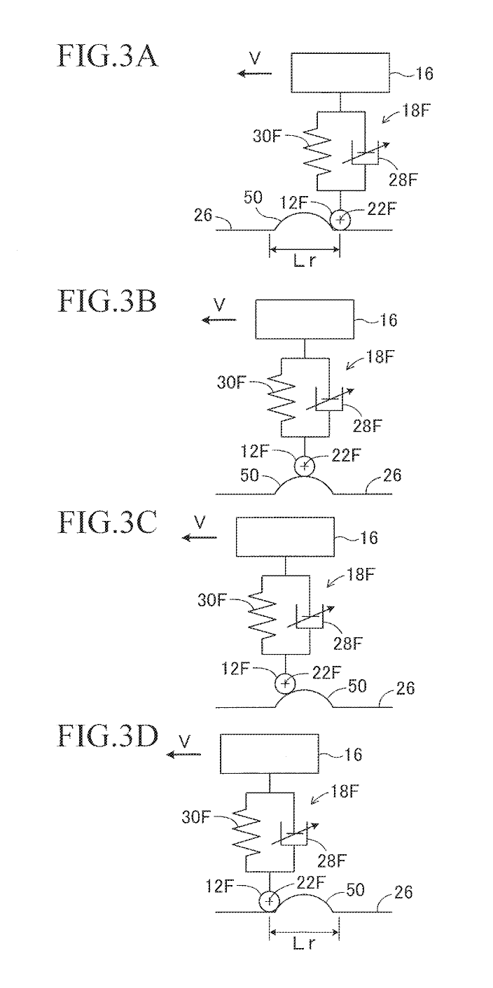

FIGS. 3A-3D illustrate a situation in which the front wheel 12F passes over a protrusion 50 with the damping coefficient C of the shock absorber 28F being maintained at a constant value for a single-wheel model of the front wheel 12F. In FIG. 3A shows a situation where the front wheel 12F has reached the protrusion 50. When the front wheel 12F rides on the protrusion 50, the suspension 18F contracts and the vehicle body 16 starts moving upward. FIG. 3B shows a situation where the front wheel 12F has substantially moved to the top of the protrusion 50. In this situation, a compression quantity of the suspension 18F is maximized, and the vehicle body 16 receives an upward force from the suspension spring 30F to further move upward with respect to the front wheel 12F.

FIG. 3C shows a situation where the front wheel 12F has passed the top of the protrusion 50. Also in this situation, since the suspension 18F is in a contracted state, the vehicle body 16 continues to move upward with respect to the front wheel 12F. FIG. 3D shows a situation where the front wheel 12F has gotten over the protrusion 50. In this situation, the compression quantity of the suspension 18F becomes zero, and the upward force which the vehicle body 16 receives from the suspension spring 30F also becomes zero.

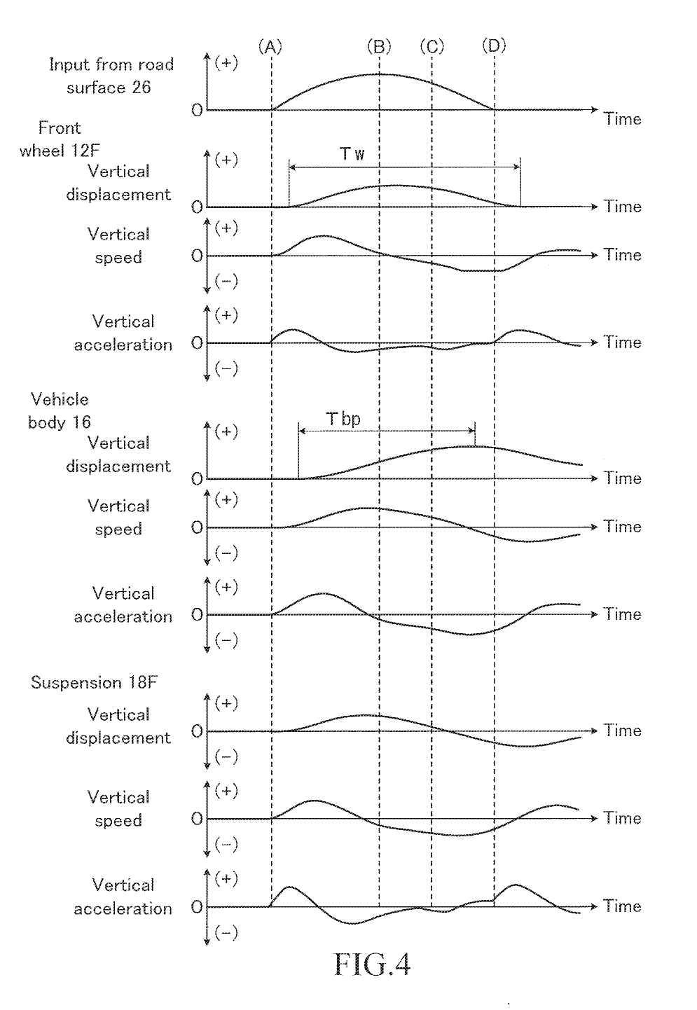

FIG. 4 shows an example of changes of an input from the road surface 26, vertical displacements of the front wheel 12F (unsprung mass), the vehicle body 16 (sprung mass) and a suspension 18F, a vertical speed, and a vertical acceleration in a situation where the front wheel 12F passes over the protrusion 50 as described above with the damping coefficient C being set to the minimum value C0. Notably, in FIG. 4, as for signs of the vertical displacement and so on, the upward direction is defined as positive. The (A) through (D) correspond to FIGS. 3A to 3D, respectively.

The time period for the front wheel 12F to get over the protrusion 50, namely the time Tw from when the vertical displacement of the front wheel 12F increases from zero till when the vertical displacement returns to zero in FIG. 4, is substantially the same as the time period when there is an input from the road surface 26 (time period from FIG. 4 to FIG. 4D). However, since the estimated time Lr/V is a time period when the vehicle moves the distance Lr of a flat road at the vehicle speed V, the time Lr/V is shorter than the time Tw. It has been experimentally confirmed that the time Lr/V is the same as the time Tbp from when the vertical displacement of the vehicle body 16 increases from zero till when the vertical displacement reaches the first peak value, and this relationship is satisfied regardless of the specification of the vehicle. In addition, since the damping coefficient C is set to the minimum value C0, and the vertical vibration of the vehicle body 16 may be regarded as resonance vibration, the estimated time Lr/V is equal to a quarter of the resonance period of the of the vehicle body 16. Therefore, by calculating the resonance period Tbd of the vehicle body 16 in advance, it can be determined that the predetermined vertical displacement portion is a step when the time Lr/V is greater than ¼ of the Tbd, and it can be determined that the predetermined vertical displacement portion is a protrusion when the time Lr/V is not greater than (in other words, is equal to or less than) ¼ of the tbd.

The resonance period Tbd of the vehicle body 16 as the sprung mass is represented by the following formula (1). It should be noted that, in the following formula (1), fbnd is the resonance frequency of the vehicle body 16, and is the damping ratio of each of the shock absorbers 28F which is represented by the following formula (2). Furthermore, in the following formulas (1) and (2), ksf is the spring constant of the suspension springs 30F, and mbf is the mass of a portion of the vehicle body 16 corresponding to the front wheels 12F. Thus, on the basis of the damping coefficient C of the shock absorbers 28F, the spring constant ksf of the suspension springs 30F, and the mass mbf of a portion of the vehicle body 16 corresponding to the front wheels 12F (all of which are values already known), the resonance period Tbd of the vehicle body 16 can be calculated in advance in accordance with the following formula (1).

$$\begin{matrix}Tbd = \frac{1}{{f}_{bnd}} = \frac{2 π}{\sqrt{( 1 - {ζ}^{2} ) {k}_{sf} / {m}_{bf}}} & ( 1 ) \\ ζ = \frac{C}{2 \sqrt{{m}_{bf} {k}_{sf}}} & ( 2 )\end{matrix}$$

### <Damping Force Control Routine>

Next, with reference to the flowchart shown in FIG. 5, the damping force control routine of the shock absorber 28F of the front wheel 12F in the embodiment will be described. The control according to the flowchart shown in FIG. 5 is repeatedly executed at predetermined time intervals for each of the front wheels 12FL and 12FR, when an ignition switch (not shown in the figures) is ON. In the following description, the damping force control according to the flowchart shown in FIG. 5 will be simply referred to as “control”.

First, in step 10, a signal indicating the height of the road surface 26, which is detected by the road surface sensor 36F, and so on are read. It should be noted that, at the time of start of the control, flag Fd, count value Tr of a timer, and the elapsed time Tc, which are described later, are each reset to zero.

In step 20, it is determined whether or not the flag Fd is 1. Namely, in step 20, it is determined whether or not a determination that there is a step or a protrusion which is the predetermined vertical displacement portion has already been made, and the distances Ld and Lr described later have already been calculated. When a positive determination is made, the control proceeds to step 90, while a negative determination is made, the control proceeds to step 30.

In step 30, based on the height of the road surface 26 which is detected by the road surface sensor 36F, it is determined whether or not a step or a protrusion exists in front of the front wheel 12F. When a negative determination is made, the control proceeds to step 150, while when a positive determination is made, the control proceeds to step 40. In this case, when a region in which the height of the road surface 26 is equal to or higher than the present height by a reference value is detected, and the height of the road surface 26 up to a preset distance forward from the region is detected, it is determined that a step or a protrusion exists.

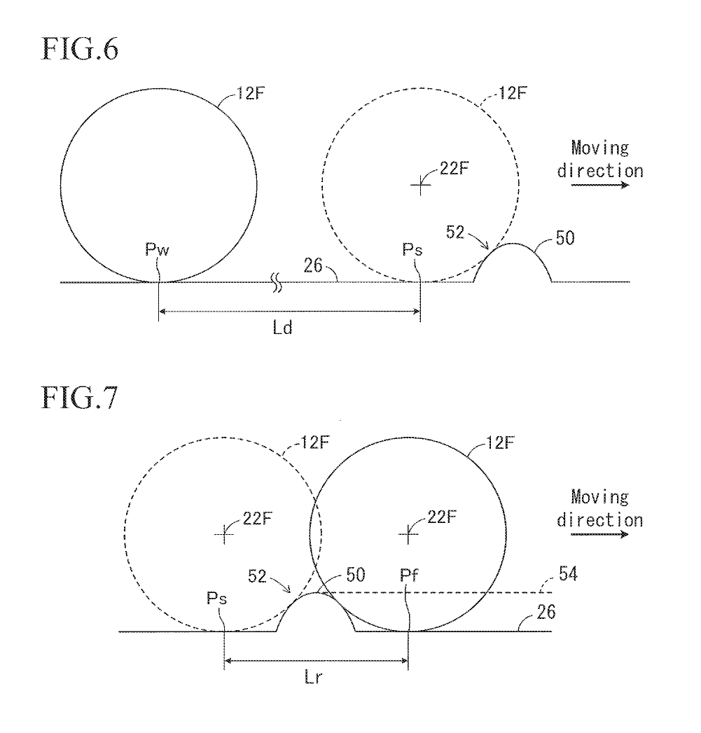

In step 40, based on the height of the road surface 26 detected by the road surface sensor 36F, as shown in FIG. 6, the distance Ld from the current grounding point Pw of the front wheel 12F to the grounding point Ps when the front wheel 12F begins to ride on the predetermined vertical displacement portion 52 is calculated. Furthermore, as shown in FIG. 7, the distance Lr from the grounding point Ps when the front wheel begins to ride on the predetermined vertical displacement portion 52 to the grounding point Pf when the front wheel 12F has completed getting over the vertical displacement portion 52 is calculated.

It should be noted that, in FIG. 7, the dashed line indicates the case where the distance Lr is equal to or greater than, for example, ½ of the outer circumference of the front wheel 12F, and the vertical displacement portion 52 should be determined to be a step 54. In this connection, the distance Lr is set to the value Lrs (positive constant) at which a positive determination is made in step 50 described later irrespective of the vehicle speed V. In contrast, when the distance Lr is less than one half of the outer circumference of the front wheel 12F, the distance Lr remains the calculated value.

In step 50, it is determined whether or not the value Lr/V obtained by dividing the distance Lr by the vehicle speed V is greater than a quarter of the resonance period Tbd of the vehicle body 16. When a negative determination is made, the control proceeds to step 70, while when a positive determination is made, the control proceeds to step 60. Notably, the resonance period Tbd of the vehicle body 16 is a value (a positive constant) calculated in accordance with the above formulas (1) and (2) in advance for the case where the damping coefficient C of the shock absorbers 28 is the minimum value C0 and stored in the ROM. The resonance period Tbd of the vehicle body 16 may be a value which is experimentally obtained. As described above, the value Lr/V is the time required for the front wheel 12F to get over and pass through the protrusion 50.

In step 60, since the predetermined vertical displacement portion may be determined to be a step as described above, the predetermined elapsed time Tc is set to the reference time Twd. In contrast, in step 70, since the predetermined vertical displacement portion may be determined to be a protrusion as described above, the elapsed time Tc is set to Lr/V+Twd, which is the sum of Lr/V obtained by dividing the distance Lr by the vehicle speed V and the reference time Twd.

Assuming that Two is one cycle (resonance period) of the vertical resonant vibration of the front wheel 12F which occurs when the front wheel 12F passes through a protrusion in a state where the damping coefficient C is set to the minimum value C0, the reference time Twd is a positive constant in the range from 0.70*Tw0 to 1.18*Tw0, and is stored in the ROM. The reason why the reference time Twd is set to the value within the above range will be described later in detail.

The resonance period Tw0 of the front wheel 12F as the unsprung mass is represented by the following formula (3). In the following formula (3) fwnd is a resonance frequency of the front wheel 12F, and is a damping ratio of the shock absorber 28F represented by the above formula (2). Furthermore, in the following formula (3), ktf is the spring constant of the tire 24F, and mwf is a mass of the front wheel 12F. Thus, on the basis of the damping coefficient C of the shock absorber 28F, a spring constant ksf of the suspension spring 30F, a spring constant ktf of the tire 24F, and the mass mwf of the front wheel 12F (all of which are values already known), the resonance period Tw0 of the front wheels 12F can be calculated in advance in accordance with the following formula (3).

$$Tw 0 = \frac{1}{{f}_{wnd}} = \frac{2 π}{\sqrt{( 1 - {ζ}^{2} ) ( {k}_{tf} + {k}_{sf} ) / {m}_{wf}}} \qquad ( 3 )$$

When the step 60 or 70 is completed, the control proceeds to step 80. In step 80, the flag Fd is set to 1 so as to show that the determination that a step or a protrusion exists, the calculation of distances Ld and Lr, and the calculation of the predetermined time Tc have already been completed.

In step 90, it is determined whether or not the front wheel 12F is about to start to run over a step or a protrusion and the damping coefficient C of the shock absorber 28 needs to be reduced to the minimum value C0. When a negative determination is made, the control proceeds to step 150, while a positive determination is made, the control proceeds to step 100. In this case, the determination as to whether or not the front wheel 12F is about to start to run over a step or a protrusion may be carried out as a determination whether or not the elapsed time from the time point when the determination (whether or not a step or a protrusion exists) in step 30 is changed from “no” (negative determination) to “yes” (positive determination) is equal to or more than Ld/V−α (α is, for example, a constant of 1 second to 10 seconds).

In step 100, it is determined whether or not the front wheel 12F has started to run over a step or a protrusion. Namely, it is determined whether or not it is just the timing when the front wheel 12F begins to run over a step or a protrusion or it is just after that timing. When a negative determination is made, the control proceeds to step 130, while a positive determination is made, the control proceeds to step 110. In this case, the determination in step 100 may be carried out as a determination whether or not the elapsed time from the time point when the determination (whether or not a step or a protrusion exists) in step 30 is changed from “no” to “yes” is equal to or more than Ld/V.

In step 110, the count value Tr of the timer indicating the elapsed time from the time when the front wheel 12F begins to run over a step or a protrusion is incremented by ΔT (a positive constant) which is the cycle time of the control process.

In step 120, it is determined whether or not the count value Tr of the timer is equal to or more than the predetermined elapsed time Tc which is the reference value. Namely, in step 120, it is determined whether or not the reduction of the damping coefficient C of the shock absorber 28F should be ended. When a negative determination is made, the damping coefficient C is set to or maintained at the minimum value C0 in step 130, while a positive determination is made, the flag Fd, the count value Tr of the timer, and the predetermined elapsed time Tc are reset to 0 respectively in step 140.

In step 150, the normal damping force control of the shock absorber 28F is carried out. In other words, the damping coefficient C of the shock absorber 28F is controlled in accordance with the normal control law such as the Sky hook theory, the H∞ control theory, or the like.

Next, the reason why the reference time Twd which is described in steps 60 and 70 is set to the value within the above range (0.70*Tw0 to 1.18*Tw0) will be explained. Noted that, in the following description, the minimum value C0 of the damping coefficient C is set to 1000 Ns/m (damping ratio ζ=0.1) which is a soft value.

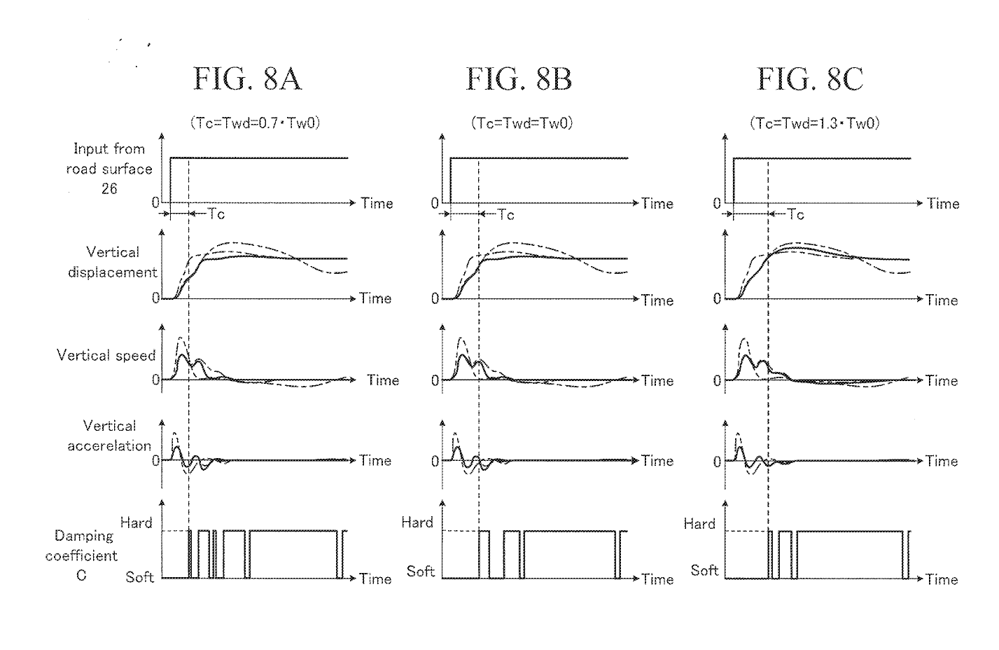

The solid lines in FIGS. 8A, 8B and 8C show an example of changes of an input from the road surface 26, a vertical displacement of the vehicle body 16, a vertical speed, a vertical acceleration, and a damping coefficient when the front wheel 12 runs over and passes through a step. In particular, FIG. 8A shows a case where the predetermined elapsed time Tc is 0.7*Tw0 smaller than the lower limit value 0.71*Tw0 of the above-mentioned range. FIG. 8B shows a case where the predetermined elapsed time Tc is Tw0 which is a value within the above range. FIG. 8C shows a case where the predetermined elapsed time Tc is 1.3*Tw0 larger than the upper limit value 1.18*Tw0 of the above-mentioned range.

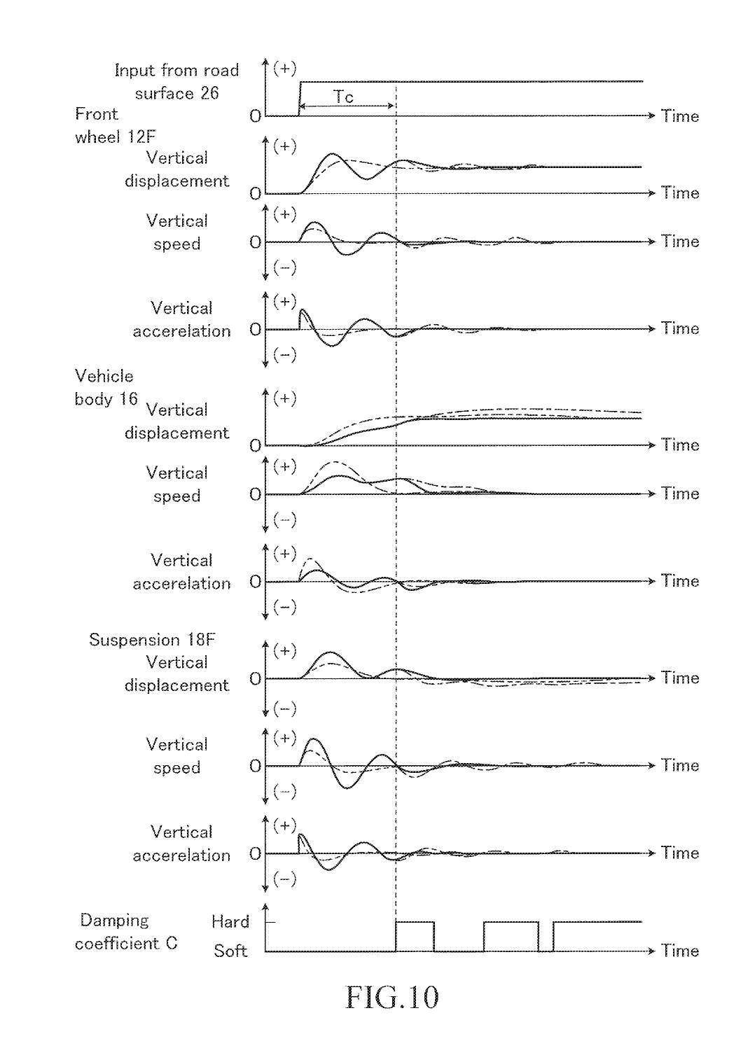

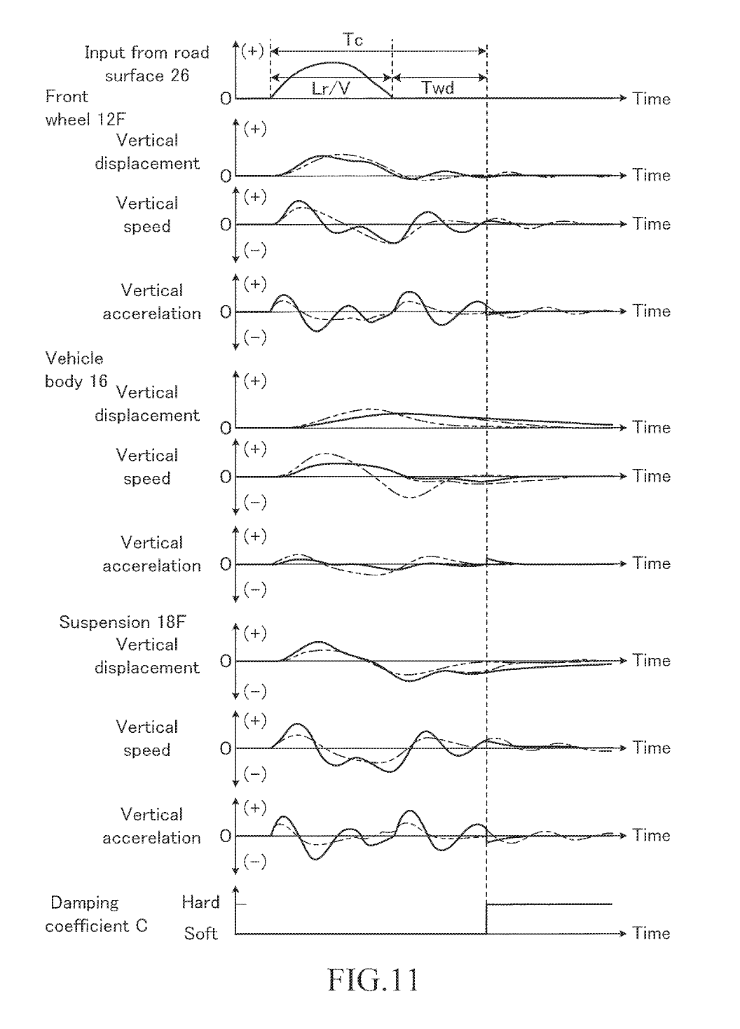

Noted that, in FIGS. 8A, 8B and 8C, the one-dot chain lines show values when the damping coefficient C of the shock absorber 28F is set to a constant value corresponding to the soft value, and the two-dot chain lines show values when the damping coefficient C of the shock absorber 28F is set to a constant value corresponding to a hard value which is 5000 Ns/m (damping ratio ζ=0.7). The radius of the front wheel 12F is 465.5 mm, and the height of the step is 50 mm. Furthermore, each lowest part of FIGS. 8A, 8B and 8C show changes of the damping coefficient C of the shock absorber 28F which is simply controlled to be the soft value and the hard value in accordance with the normal control law based on the Skyhook theory. This also applies to FIGS. 10 and 11 described later.

In the case shown in FIG. 8A, the vertical displacement of the vehicle body 16 can be effectively reduced when the damping coefficient C of the shock absorber 28F is controlled in accordance with the normal control law, i.e., after the predetermined elapsed time Tc passes. However, as compared with the case where the damping coefficient C is set to the soft value, the damping performance of the vertical acceleration of the vehicle body 16 is not sufficient after lapse of the predetermined elapsed time Tc. On the contrary, in the case shown in FIG. 8C, the vibration of the vertical acceleration of the vehicle body 16 after lapse of the predetermined elapsed time Tc can be effectively reduced. However, as compared with the case where the damping coefficient C is set to the hard value, the vertical displacement of the vehicle body 16 after lapse of the predetermined elapsed time Tc cannot be effectively reduced.

In contrast, in the case shown in FIG. 8B, the vertical displacement of the vehicle body 16 after lapse of the predetermined elapsed time Tc can be effectively reduced as compared with the case shown in FIG. 8C. Further, the vertical acceleration of the vehicle body 16 after lapse of the predetermined elapsed time Tc can be damped quickly as compared with the case shown in FIG. 8A.

It should be noted that, in any of these cases shown in FIGS. 8A to 8C, the vertical displacement and the vertical acceleration of the vehicle body 16 up to the lapse of the predetermined elapsed time Tc can be effectively reduced as compared with the case where the damping coefficient C is set to a constant value of the hard value. Thus, until the predetermined elapsed time Tc passes, it is estimated that the vertical displacement and the vertical acceleration of the vehicle body 16 can be effectively reduced as compared with the case where the damping coefficient C is controlled to be a value close to the hard value, in other words, a value greater than the minimum value C0.

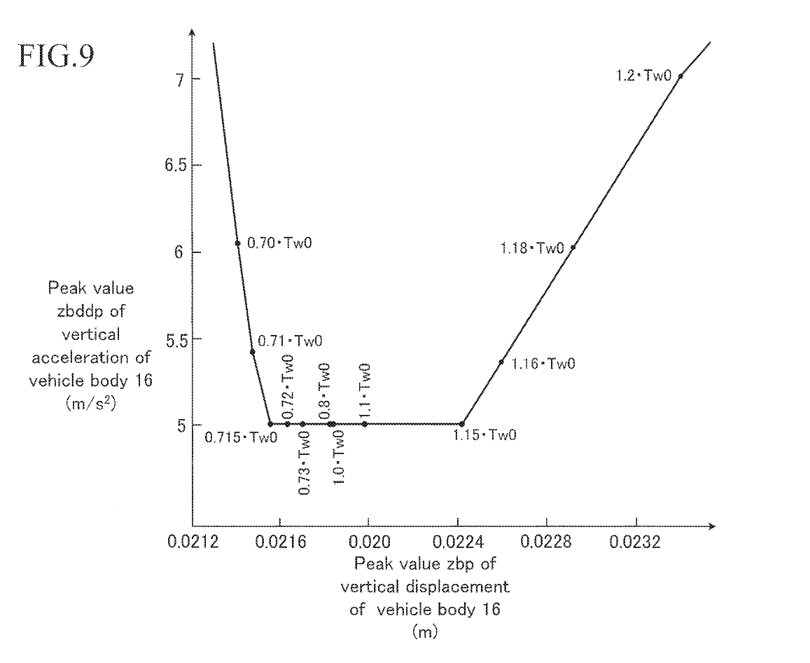

FIG. 9 shows an example of a relationship between the peak value zbp of the vertical displacement of the vehicle body 16 and the peak value zbddp of the vertical acceleration of the vehicle body 16 for various values of the predetermined lapsed time Tc when the front wheel 12F runs over and passes through the step. On the basis of FIG. 9, it can be understood that the reference time Twd is preferably 0.70*Tw0 or more and 1.18*Tw0 or less in order to reduce the peak value zbddp of the vertical acceleration of the vehicle body 16 while preventing the peak value zbp of the vertical displacement of the vehicle body 16 from excessively increasing when the front wheel 12F runs over and passes through the step. In particular, it can be understood that the reference time Twd is preferably 0.71*Tw0 or more, more preferably 0.715*Tw0 or more and is preferably 1.16*Tw0 or less, more preferably 1.15*Tw0 or less.

It should be noted that, although not shown in the figures, the relationship between the peak value zbp of the vertical displacement of the vehicle body 16 and the peak value zbddp of the vertical acceleration of the vehicle body 16 after the front wheel 12F has gotten over the protrusion is the same as that shown in FIG. 9. Therefore, the reference time Twd is preferable to be within the above range in order to reduce the peak value of the vertical acceleration of the vehicle body 16 while preventing the peak value of the vertical displacement of the vehicle body 16 from excessively increasing after the front wheel 12F has gotten over the protrusion.

### <Operation of the Damping Force Control Apparatus 10>

Next, the operation of the damping force control apparatus 10 configured as above will be described for various cases.

### (1) Determination of Presence or Absence of a Step or a Protrusion

In step 30, it is determined whether or not the predetermined vertical displacement portion, that is, a step or a protrusion, exists in front of the front wheel 12F. When it is determined that there is no step or protrusion, in step 150 the normal damping force control of the shock absorber 28F is carried out. On the other hand, when it is determined that a step or a protrusion exists, in step 40, the distance Ld from the touchdown point Pw of the front wheel 12F to the touchdown point Ps when the front wheel begins to run over a step or a protrusion is calculated, and the distance Lr from the touchdown point Ps to the touchdown point Pf when the front wheel 12F has completed getting over a protrusion is calculated. Furthermore, in step 50, it is determined whether the predetermined vertical displacement portion is a step or a protrusion by determining whether or not the value Lr/V obtained by dividing the distance Lr by the vehicle speed V is greater than ¼ of the Tbd.

(2) The Case where the Predetermined Vertical Displacement Portion is a Step

A positive determination is made in step 50, and in step 60 the predetermined elapsed time Tc is set to the reference time Twd. A positive determination is made in step 90 and a negative determination is made in step 100 immediately before the front wheel 12F reaches a step. As a result, in step 130, the damping coefficient C of the shock absorber 28F is reduced to the minimum value C0. Therefore, since the damping coefficient C of the shock absorber 28F can be reduced to the minimum value C0 immediately before the front wheel 12F runs over a step, it is possible to reduce the degree of impact which the front wheel 12F gets from a step when the front wheel 12F runs over the step.

In addition, when the front wheel 12F reaches a step, a positive determination is made in step 100, and the count value Tr of the timer is started to be incremented in step 110. When an elapsed time (Tr) from the time when the front wheel 12F reaches a step is less than the predetermined elapsed time Tc, a negative determination is made in step 120. Therefore, since the damping coefficient C of the shock absorber 28F is maintained at the minimum value C0, the situation can be continued where the degree of transmitting impact, which the front wheel 12F gets from a step, to the vehicle body 16 is reduced.

When the elapsed time (Tr) from the time when the front wheel 12F reaches a step becomes equal to or more than the predetermined elapsed time Tc, a positive determination is made in step 120. Thus, steps 140 and 150 are executed, and the damping coefficient C of the shock absorber 28F is controlled in accordance with the normal control law. Therefore, it is possible to prevent the damping coefficient C of the shock absorber 28F from being reduced to the minimum value C0 for an unnecessarily long time from the time when the front wheel 12F reaches a step, and thereby an upward displacement of the vehicle body 16 can be effectively prevented from being large.

For example, the solid lines in FIG. 10 show an example of changes of an input from the road surface 26, vertical displacements of the front wheel 12, the vehicle body 16, and the suspension 18F, a vertical speed, a vertical acceleration, and a damping coefficient when the front wheel 12F runs over and passes through a step. Noted that, the radius of the front wheel 12F is 465.5 mm, the height of the step is 50 mm, and the vehicle speed V is 10 km/h.

On the basis of FIG. 10, it can be understood that according to the embodiment, it is possible to reduce the magnitude of the vertical acceleration of vehicle body 16 immediately after the front wheel 12F runs over a step (the initial of the predetermined elapsed time Tc), and thereby the ride quality of the vehicle can be improved, as compared with the case where the damping coefficient C is constantly set to the hard value. Further, it can be understood that as compared with the case where the damping coefficient C is constantly set to the soft value, the magnitude of the vertical displacement of the vehicle body 16 after the lapse of the predetermined lapsed time Tc can be effectively reduced.

(3) The Case where the Predetermined Vertical Displacement Portion is a Protrusion

A negative determination is made in step 50, and in step 70 the predetermined lapsed time Tc is set to Lr/V+Twd. A positive determination is made int step 90 and a negative determination is made in step 100 immediately before the front wheel 12F reaches a step. As a result, in step 130, the damping coefficient C of the shock absorber 28F is reduced to the minimum value C0. Therefore, since the damping coefficient C of the shock absorber 28F can be reduced to the minimum value C0 immediately before the front wheel 12F runs over a protrusion, it is possible to reduce the degree of impact which the front wheel 12F gets from a protrusion when the front wheel 12F runs over the protrusion.

In addition, when the front wheel 12F reaches a protrusion, a positive determination is made in step 100, and the count value Tr of the timer is started to be incremented in step 110. When an elapsed time (Tr) from the time point when the front wheel 12F reaches a protrusion is less than the predetermined elapsed time Tc, a negative determination is made in step 120. Therefore, since the damping coefficient C of the shock absorber 28F is maintained at the minimum value C0, the situation can be continued where the degree of transmitting impact, which the front wheel 12F gets from a protrusion, to the vehicle body 16 is reduced.

When the elapsed time (Tr) from the time point when the front wheel 12F reaches the protrusion becomes equal to or more than the predetermined elapsed time Tc, a positive determination is made in step 120. Thus, steps 140 and 150 are executed, and the damping coefficient C of the shock absorber 28F is controlled in accordance with the normal control law. Therefore, it is possible to prevent the damping coefficient C of the shock absorber 28F from being reduced to the minimum value C0 for an unnecessarily long time after front wheel 12F has gotten over a protrusion, and thereby the upward displacement of the vehicle body 16 can effectively be prevented from being large.

For example, the solid lines in FIG. 11 show an example of changes of an input from the road surface 26, vertical displacements of the front wheel 12F, the vehicle body 16, and the suspension 18F, a vertical speed, a vertical acceleration, and a damping coefficient when the front wheel 12F gets over and passes through a protrusion. Noted that, the radius of the front wheel 12F is 465.5 mm, and the height of the protrusion is 50 mm. The distance Lr is 500 mm, and the vehicle speed V is 10 km/h. Therefore, the estimated time Lr/V is 0.18 sec. In addition, the reference time Twd is Tw0.

On the basis of FIG. 11, it can be understood that according to the embodiment, it is possible to reduce the magnitude of the vertical acceleration of vehicle body 16 for a period of time from when the front wheel 12F begins to run over a protrusion until the predetermined elapsed time Tc passes, and thereby the ride quality of the vehicle can be improved, as compared with the case where the damping coefficient C is set to the hard value. Further, it can be understood that the magnitude of the vertical acceleration of the vehicle body 16 after the predetermined elapsed time Tc passes is about the same as in the case where the damping coefficient C is set to the hard value.

(4) The Case where the Predetermined Vertical Displacement Portion does not Exist

In steps 20 and 30 negative determinations are made, and step 150 is executed, thereby the damping coefficient C of the shock absorber 28F is controlled in accordance with the normal control law. Thus, without unnecessarily reducing the damping coefficient C of the shock absorber 28F to the minimum value C0, the damping force of the shock absorber 28F can be controlled in accordance with the normal control law.

It should be noted that, whenever the predetermined vertical displacement portion is either of a step or a protrusion, the damping coefficient C of the shock absorber 28F can be controlled in accordance with the normal control law until just before the front wheels 12F runs over the step or the protrusion. Therefore, since the damping coefficient C is not set unnecessarily to a low value during normal running of the vehicle, it is possible to properly damp the vibration of the vehicle body 16 during normal running to secure good ride quality and driving stability of the vehicle.

The damping coefficient C of the shock absorber 28F of the front wheel 12F in the embodiment is controlled as described above. When the road surface 26 has a step or a protrusion, the damping coefficient of the shock absorber 28R of the rear wheel 12R may be controlled in the same manner as the damping coefficient C of the shock absorber 28F of the front wheel 12F with a delay by the time Lw/V which is required for the vehicle 14 to move the distance equal to the wheelbase Lw at the vehicle speed V.

In the above, although the specific embodiment of the present disclosure has been described in detail. However, it is apparent to person skilled in the art that the present disclosure is not limited to the above embodiment, and various other embodiments can be carried out within the scope of the present disclosure.

For example, in the above embodiment, the control of the damping coefficient according to the flowchart shown in FIG. 5 is executed repeatedly at predetermined time intervals for each of the front wheels 12FL and 12FR. However, the present disclosure may be modified so that when it is determined that a predetermined vertical displacement portion exists in front of only one of the front wheels 12FL and 12FR, the damping coefficient corresponding to the other of the front wheels 12FL and 12FR is controlled in synchronization with the control of the damping coefficient corresponding to the one of the front wheels 12FL and 12FR.

In the embodiment described above, when a positive determination is made in step 120, in other words, when it is determined that reduction of the damping coefficient C of the shock absorber 28F should be ended, in step 150 the normal damping force control of the shock absorber 28F is carried out. However, the present disclosure may be modified so that when a positive determination is made in step 120, the damping coefficient C is controlled to be a high damping coefficient for a predetermined period of time, and then the normal damping force control is carried out.

In the embodiment described above, the damping coefficient C for reducing the impact when the front wheel 12F passes through the predetermined vertical displacement portion is the minimum value C0 smaller than the minimum value C0+x which the damping coefficient C takes in the normal damping force control. However, the damping coefficient C for reducing the impact when the front wheel 12F passes through the predetermined vertical displacement portion may be the minimum value C0+x which the damping coefficient C takes in the normal damping force control.

Further, in the above description of the embodiment does not refer to the case where the predetermined vertical displacement portion is a recess on a road surface. However, a recess of a road surface may be determined to be a step or a protrusion depending on the shape of the region where the front wheel 12F reaches a higher position of the recess from the lower position of the recess.

1. A damping force control apparatus for a vehicle configured to control a damping force variable type shock absorber which is disposed between each of front wheels and a vehicle body and is configured to vary a damping coefficient to a plurality of values, comprising:
a road surface sensor configured to detect a vertical displacement of a road surface at a position which is spaced forward from said front wheel by a predetermined distance;
a vehicle speed sensor configured to detect a vehicle speed; and
a control unit configured to control the damping coefficient of each shock absorber in accordance with a predetermined control law, wherein,
said control unit is configured to store a reference time preset to a value within a predetermined range including a time period of a resonance period of said front wheels when said damping coefficient of said shock absorber is the minimum value among said plurality of values,
said control unit is configured:
when determining that there is a predetermined vertical displacement portion giving an upward excitation force to the front wheel in front of the front wheel based on a vertical displacement of said road surface detected by said road surface sensor, to estimate a timing when the front wheel reaches a predetermined vertical displacement portion based on the vehicle speed detected by said vehicle speed sensor and said predetermined distance;
to set said damping coefficient to said minimum value without following said predetermined control law by said timing is reached;
to set a predetermined elapsed time from said timing during which said damping coefficient is maintained at said minimum value based on said reference time; and
to return control of said damping coefficient to the control in accordance with said predetermined control law when said predetermined elapsed time has elapsed from said timing.

2. A damping force control apparatus for a vehicle according to claim 1, wherein,
said control unit is configured:
to estimate a time required for the front wheel to pass through said predetermined vertical displacement portion based on the vehicle speed detected by said vehicle speed sensor and a magnitude of said predetermined vertical displacement portion measured in a direction of movement of the front wheel, and to determine that said predetermined vertical displacement portion is an upward step when the estimated time is greater than a quarter of the time period of the resonance period of said vehicle body in the case where said damping coefficient of said shock absorber is said minimum value;
to determine that said predetermined vertical displacement portion is a protrusion when said estimated time is not greater than a quarter of the time period of said resonance period of said vehicle body; and
to set said predetermined elapsed time in accordance with the result of the determination.

3. A damping force control apparatus for a vehicle according to claim 1, wherein,
said control unit is configured to set said predetermined elapsed time to said reference time when determining that said predetermined vertical displacement portion is an upward step.

4. A damping force control apparatus for a vehicle according to claim 1, wherein,
said control unit is configured to estimate a time period from said timing until a time point when the front wheel has gotten over said protrusion based on the vehicle speed detected by said vehicle speed sensor and a magnitude of said predetermined vertical displacement portion measured in a direction of movement of the front wheel, and to set said predetermined elapsed time to a sum of said estimated time period and said reference time when determining that said predetermined vertical displacement portion is a protrusion.

5. A damping force control apparatus for a vehicle according to claim 1, wherein,
said reference time is not less than 0.70 times said time period of the resonance period of the front wheel and is not more than 1.18 times said time period of the resonance period of the front wheel.
